(19) United States
(12) Patent Application Publication
(10) Pub. No.: US 2017/0011387 A1
(43) Pub. Date: Jan. 12, 2017

(54) SYSTEMS AND ASSOCIATED METHODS FOR EXCHANGING GIFT CARDS

(71) Applicant: Outerwall Inc., Bellevue, WA (US)

(72) Inventors: Kevin V. Lennon, Maple Valley, WA (US); Jeffrey H. Lail, Taylorsville, NC (US)

(21) Appl. No.: 14/794,603

(22) Filed: Jul. 8, 2015

(51) Int. Cl. G06Q 20/34; G06Q 20/42; G06Q 20/18; G06Q 20/24

(52) U.S. Cl. CPC G06Q 20/342; G06Q 20/24; G06Q 20/42; G06Q 20/18

(57) ABSTRACT

The present disclosure is directed a gift card exchange server and associated systems and methods that are configured to receive information about a gift card that a user would like to sell. The gift card exchange server determines an offer for the gift card and transmits the offer to a computing device for presentation to the user. In one embodiment, if the offer is accepted, the user is queried to see if they would like the proceeds from the sale to be applied as a credit to an account, such as an on-line retailer account. If so, the server sends a message to the account indicating that a credit is to be given to the user along with an indication that the credit is conditioned upon completing a transaction and/or draining the purchased gift card of funds. The user can use the credit to purchase goods or services. However, the purchase transaction will not be consummated or the goods and services will not be shipped until the exchanged gift card is redeemed or the server computer otherwise confirms that the server system has received the value from the gift card. Once the server computer receives an indication that the card value has been received, the server computer sends a message to release a hold on the credit.

### CROSS-REFERENCE TO APPLICATION(S) INCORPORATED BY REFERENCE

The disclosures of U.S. patent application Ser. No. 11/294,637, titled “METHODS AND SYSTEMS FOR EXCHANGING AND/OR TRANSFERRING VARIOUS FORMS OF VALUE,” filed Dec. 5, 2005; U.S. patent application Ser. No. 10/558,907, titled “METHODS AND SYSTEMS FOR PROVIDING PRODUCTS, SUCH AS DIGITAL CONTENT INCLUDING GAMES, RING TONES, AND/OR GRAPHICS; AND SERVICES, SUCH AS COMPUTER NETWORK SERVICE INCLUDING INTERNET SERVICE,” filed Feb. 7, 2007; U.S. Pat. No. 8,332,313, titled “METHODS AND SYSTEMS FOR EXCHANGING AND/OR TRANSFERRING VARIOUS FORMS OF VALUE,” filed Jul. 22, 2008; U.S. Pat. No. 8,024,272, titled “METHODS AND SYSTEMS FOR EXCHANGING/TRANSFERRING GIFT CARDS,” filed Apr. 12, 2010; U.S. Pat. No. 8,229,851, titled “METHODS AND SYSTEMS FOR EXCHANGING/TRANSFERRING GIFT CARDS,” filed Aug. 19, 2011; U.S. patent application Ser. No. 13/286,971, titled “GIFT CARD EXCHANGE KIOSKS AND ASSOCIATED METHODS OF USE,” filed Nov. 1, 2011 U.S. patent application Ser. No. 14/312,393, titled “PREPAID CARD EXCHANGE SYSTEMS AND ASSOCIATED METHODS,” filed Jun. 23, 2014; and U.S. patent application Ser. No. 14/617,672, titled “MOBILE SYSTEM FOR EXCHANGING GIFT CARDS,” filed Mar. 9, 2015, are incorporated herein by reference in their entireties.

### TECHNICAL FIELD

The present disclosure relates generally to systems, apparatuses, and methods for exchanging gift cards and, more particularly, to platforms for exchanging gift cards for cash, cash vouchers, other gift cards, credit, etc.

### BACKGROUND

Gift cards and other prepaid cards are restricted monetary equivalents issued by retailers or banks that consumers can use as an alternative to currency for purchasing goods, services, etc. While prepaid cards rank as one of the most popular gifts given by consumers in the United States, an estimated $8 billion worth of unused and/or expired gift card value, referred to as “breakage,” occurs annually. Various methods have been proposed to reduce breakage. Some websites, for example, provide consumers with the ability to sell unwanted gift cards by auction. Other websites provide consumers with the ability to exchange unwanted gift cards for cash through the mail. Additionally, kiosks, such as those operated by Outerwall, Inc., the assignee of the present application, allow consumers to exchange gift cards for a cash voucher that can be exchanged for cash or used to purchase goods at a participating retailer. While such kiosks offer a convenient way to exchange gift cards for cash or other items of monetary value, the owner of the gift card must usually be present at the kiosk to conduct the transaction. There is therefore a need to provide users with other ways of exchanging gift cards without having to physically visit a kiosk in order to conduct the entire transaction, while simultaneously protecting the operator of the exchange system against fraud.

One of the most common sources of fraud in the gift card exchange business model is referred to as “double dipping.” For example, an unscrupulous cardholder could write down the identification number associated with a $100 gift card, and then exchange the card for a cash voucher using, e.g., a gift card exchange kiosk. The cardholder could then redeem the $100 card value (e.g., by using the copied identification number to make, for example, an online purchase) before the card has been resold or otherwise monetized by the kiosk operator. Accordingly, it would be advantageous to provide a financially secure gift card exchange system that prevents unscrupulous consumers from misappropriating card value while still providing the user with the ability to exchange cards for cash or cash value.

### BRIEF DESCRIPTION OF THE DRAWINGS

FIG. 1 illustrates a system for facilitating the exchange of gift cards using a remotely located computing device in accordance with an embodiment of the present disclosure.

FIG. 2 is a flow chart of acts performed by a server computer in response to a user submitting information about a gift card to be exchanged in accordance with an embodiment of the present disclosure.

FIG. 3 is a flow chart of acts performed by a server computer in response to a user submitting information about a gift card to be exchanged in accordance with another embodiment of the present disclosure.

### DETAILED DESCRIPTION

The present disclosure describes various embodiments of systems and methods for exchanging various types of prepaid cards (e.g., gift cards), gift card facsimiles, and similar financial instruments (herein referred to as “gift cards” unless indicated otherwise) for cash, a cash voucher, another gift card, a credit on an e-wallet or in a customer account, etc. Such methods and systems can include, for example, ways for consumers to monetize their unused or unwanted gift cards using a general purpose computer system (e.g. a personal computer), their smart phone and/or other mobile electronic device.

As indicated above, the term “gift card” can generally refer to a “financial instrument” that may resemble a credit card, a card facsimile, a voucher, etc., or an electronic equivalent of these things, and has a monetary value (i.e., a face value or balance value). A gift card typically includes a gift card identifier (e.g., an alphanumeric code) that is cross-linked to the gift card's balance. Gift cards can include barcodes, magnetic stripes, processors (e.g., smart chips), optical media, and/or other media for recording gift card identifiers, codes, values, and/or other suitable information. As used herein, the term “gift card” can also encompass virtual gift cards that can be delivered via e-mail, text messages, or by mobile phone applications (e.g., iPhone applications) and displayed using a computer (desk top, laptop, tablet or the like), smart phone, personal digital assistant (PDA), and/or other suitable devices. Gift cards may be open loop or closed loop cards. Banks or credit card companies can issue open loop cards that can be redeemed at different commercial establishments. Conversely, restaurants, stores, and other retail establishments generally issue closed loop cards that are valid only for use at the retail establishment or its retail partners. Accordingly, although the term “gift card” may be used herein for ease of reference, the term will be understood to include other financial instruments unless the context dictates otherwise.

In accordance with one or more embodiments of the present disclosure, a computer system associated with a gift card exchange service can receive information about a gift card and/or gift card identifier from a consumer wishing to exchange the gift card, verify the gift card's activation status and value, and provide exchange options to a consumer. The options can include, for example, exchanging the gift card for a cash voucher, cash, another gift card of, e.g., a different brand or a same brand and/or a different retailer or the same retailer, and/or other types of remuneration or cash equivalent (e.g. bitcoins), cryptographic currencies, credit, payment to reduce a credit card balance or other loan balance, an e-certificate, a deposit to an on-line payment account, etc. After receiving the gift card information from the consumer and authorizing payment in the desired form in exchange for the card, the exchange service can update a gift card database to reflect the exchange and resell the gift card or the gift card value to another consumer or service via, e.g., an online or electronic marketplace (e.g., a website) or other marketplace.

As discussed above, in some currently available implementations of gift card exchange services, a user has to physically present the gift card that they wish to exchange at a kiosk or submit the card identifier to an on-line gift card exchange service. Such a purchaser could be a live agent of the service but is more likely a kiosk that is programmed to read the card and present the owner an offer. While the kiosk system works well, the system does not give the user the ability to exchange cards from any location. U.S. patent application Ser. No. 14/617,672 titled MOBILE SYSTEM FOR EXCHANGING GIFT CARDS, which is herein incorporated by reference, addresses this problem with a system whereby a user can provide gift card information to a gift card exchange service using a mobile computing device at any location where the mobile computing device can establish a communication connection with the gift card change service. In one embodiment, the mobile computing device is a smart phone. However, it will be appreciated that other mobile computing devices could be used, such as tablet computers (e.g. Apple iPad, Microsoft Surface, etc.), laptop computers, smart watches, personal digital assistants (PDAs) or other devices that can run an application program and include a mechanism for entering gift card information, such as a touch screen, keyboard, camera, voice recognition software or the like.

While a system that allows a user to start a gift card exchange transaction from any location increases the likelihood that users will redeem their unwanted cards, the users generally do not get the satisfaction of having made the exchange until the system subsequently confirms that the card has been physically turned in (via e.g. a kiosk) and/or has otherwise been drained of funds. This confirmation is desirable to prevent the double dipping problem described above and ensures that the exchange service will be compensated for exchanging the gift card. While it is possible to trust every customer at least once and issue a credit via PayPal® or other electronic funds transfer mechanism, it is inevitable that some fraud will occur. Therefore, there is a need for further improvements that allow the user to immediately realize some benefit from having exchanged a card, while limiting the chance that the operator of the gift card exchange will be defrauded.

As will be described in further detail below, the disclosed technology is a system whereby a user can initiate a transaction to exchange a gift card for value from a remotely located, fixed or mobile computing device. Once the user accepts an offer to exchange the gift card, the user is given one of several options for receiving remuneration. In one embodiment, the user can elect to receive a code or voucher that can be redeemed for cash or others items of value at a kiosk or other location once the gift card has been physically turned in or has been electronically drained of value.

In another embodiment, the user can elect to receive a temporary credit on an account associated with a partnering business or in the user's e-wallet. The user can immediately begin shopping for goods and services with the credit and can select items for purchase. However, in one embodiment, the items and/or services selected for purchase are not fully paid for or are not shipped to the purchaser, until the gift card exchange notifies the selling retailer that the credit has been confirmed (i.e. that the gift card has been received from the user or the gift card value has otherwise been received). The temporary credit gives the user the satisfaction of being able to use their new account balance to immediately shop for products and services, but protects the gift card exchange operator from paying for depleted or valueless gift cards. In another embodiment, the gift card exchange operator requests a partial refund of the gift card value from the original card issuer. Once the refund is received, the gift card exchange operator notifies the selling retailer to release a hold on the credit advanced to the gift card seller. The refund requested may be for all or a portion of the value remaining on the gift card when it is exchanged.

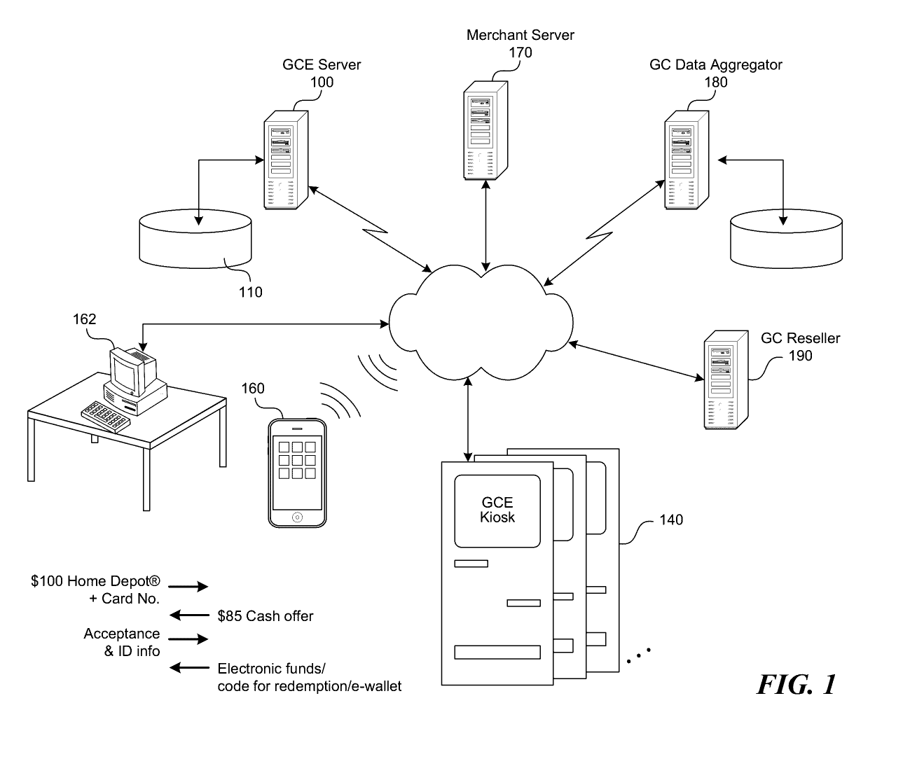

FIG. 1 shows a representative system for allowing a user to exchange a gift card from a remotely located computing device, such as a desktop or laptop computer 162, a smart phone 160, personal digital assistant, tablet computer (e.g. iPad, Microsoft Surface, Amazon Fire), etc. A gift card exchange (GCE) server computer 100 is coupled to a communication link, such as the Internet, so that it can communicate with other remotely located electronic devices. The server computer 100 is programmed to receive gift card identifying information, such as the issuer of the gift card, the card number or other identifying information, and the card value. The server computer is also programmed to provide an offer for the card and to initiate the transfer of value if the offer is accepted. In addition, the server computer 100 keeps a record of gift cards that were exchanged and the prices paid for the cards in a database 110.

In the example shown, the gift card exchange server computer 100 is programmed to communicate with a number of kiosks 140 at which customers can exchange gift cards for value. The server computer 100 interacts with the kiosks 140 to obtain information about the gift cards that were purchased from users as well as the prices paid, for storage in the database 110. In this way, the server computer 100 can operate to cancel or otherwise disable the card numbers associated with the purchased cards so that it is less likely that a seller of the card will be able to use the card number to make other purchases with the card number or sell the card to another party. Methods for disabling a card number can include those described in U.S. patent application Ser. No. 14/312,393, which is incorporated by reference in its entirety.

In accordance with one embodiment of the disclosed technology, the server computer 100 receives communications from a remotely located computing device, such as a user's computer 162 or smart phone 160. The user has loaded application software onto their computing device that allows the user to enter information about gift cards that the user wishes to exchange in order to receive an offer for such cards. The user can download the application software from an application store or a website associated with the gift card exchange server 100. As an alternative to using a dedicated application, the user can interact with the server computer 100 via the personal computer or mobile computing device using a browser program. Gift card information can be entered into one or more web pages that are transmitted from the server computer 100 to the corresponding user computing device.

To exchange a gift card, the user provides the server computer 100 with gift card information, such as the card issuer, the card value, the card numbers, etc., by typing such information onto a user interface screen of the application or a web page from the server computer 100. Alternatively, the user can capture an image of the gift card (e.g. the gift card number) using a built-in camera on their phone or computing device. The card information is sent via the communication link to the gift card exchange server 100 in order to solicit an offer for the value of the card. Upon receipt of the gift card information, the server computer reads the submitted information and/or analyzes the image of the card to determine the card information necessary to confirm whether to make an offer to the user.

As an example, assume that a user has a $100 gift card from the Home Depot® but doesn't have a need for any home building products. The user enters the card information (e.g. a card number “12345”) into a web page from the gift card exchange server 100 or the application software via their mobile computing device. The gift card exchange server 100 verifies the value of the card either by checking to see if the card number (e.g. 12345) is stored in its database 110, by communicating with the merchant 170 who initially sold the card or by checking with a third party gift card data aggregator 180 that keeps records of gift cards that have been exchanged and their value, etc. The gift card number is checked to confirm the value remaining on the card and that the value hasn't already been spent by the user or is otherwise exhausted.

Assuming that the card still has some face value (e.g. its full face value of $100), the gift card exchange server 100 determines an appropriate offer for the card and transmits the offer back to the user. In the example shown, an offer of $85 cash is made for the $100 gift card. The user then interacts with the server computer 100 via e.g., a key pad on their computing device 160, 162 to either accept or reject the offer. If the offer is rejected, the transaction ends.

If the offer is accepted, the user is prompted to provide confirmation of their identity (e.g. personal ID information) via their computing device. Such information could be a driver's license number, passport information, biometric information (photograph, thumb print, retina scan or the like), etc. The acceptance and the personal ID information are sent back to the exchange server 100 which begins processing the transaction. In one embodiment, the gift card exchange server checks the received personal ID information to see if the user is on a “banned” or “blocked customer” list. If so, the transaction is halted. If the user is not on the banned customer list, the user is asked if they would like to receive the funds electronically. If so, the user is asked to provide an account (such as a PayPal® account, an Amazon® account or other on-line account, or a bank account, an e-wallet account, a credit card account, etc.) that indicates where the funds are to be applied. The gift card exchange server 100 then issues a temporary credit for the amount of the offer to the indicated account via e.g. a remote clearing house and/or money transfer network.

In another embodiment, the temporary credit for the gift card sale is applied to the user's account with a participating merchant. For example, if the user requests that a credit be applied to their Amazon® account, the server 100 sends a message to a computer system (or an account representative) associated with Amazon.com that indicates the identity of the user along with the credit amount. Alternatively, the server computer 100 can prompt the user for their account information. For example, if the user has a Starbucks® card or an e-wallet account, the user can provide the account information for the card or e-wallet to the server 100, and the server can send a message to a computer (or account representative) that keeps track of the account balance indicating that the customer should be given a temporary credit. The message indicates that the credit should be marked as temporary (or escrowed) until the gift card sale transaction is completed by e.g., the user providing the gift card to a kiosk.

In one embodiment, the user is allowed to immediately begin shopping for goods and services using the temporary credit, but the user is not allowed to pay for the items with the credit in a brick and mortar store or an on-line store until a hold on the credit is released. The credit is released by e.g., the user depositing the card in a kiosk 140 and the kiosk 140 communicating with the gift card exchange server 100 to confirm that the card was received and that it retains value. In this embodiment, the user does not have to physically return the sold gift card to the gift card exchange before the user can begin shopping. This may allow a user to take advantage of limited time offers or the like that may expire before the transaction can be completed. In addition, the gift card exchange operator is protected because it does not release the funds to consummate the purchase transaction until the card is fully redeemed. In an alternative embodiment, the user can use the credit to pay for purchased goods but the order is not released for shipping or the services are not performed until the card is received and the transaction is completed. Before the temporary credit is issued or before a hold on an issued credit is released, the gift card exchange server takes one or more steps to ensure that the gift card still has value so that the gift card exchange can be paid for making the transaction.

In one embodiment, the gift card exchange server 100 begins a “drain and re-issue” process as described in U.S. patent application Ser. No. 14/312,393, filed Mar. 26, 2014, which was incorporated by reference above. In the drain and reissue process, the card balance is drained by using the balance on the card to purchase a new gift card from the original card issuer. The original card that has been redeemed no longer has any value so there is no chance of double dipping and the new card can be sold to a third party or re-seller. Depending on the customer relationship between the gift card exchange and the original issuer of the card, it may or may not be necessary to have physical possession of the card before it can be drained. For example, Home Depot may accept the authority of the gift card exchanger server to request that the gift card be drained of value and a new card issued upon the presentation of the correct card number. Alternatively, the original issuer may want confirmation that the original card has not been redeemed before it will drain the card of value and issue a new card. In this example, the credit may not be released by the gift card exchange server 100 until the new card is issued.

In one embodiment of the drain and reissue process, the original card issuer is not affected by the sale of the card to the gift card exchange. The original issuer keeps the original purchase price of the card and the gift card exchange only makes money on the difference between what they paid for the original card and what they can sell the new card for.

Continuing with the example described above, the gift card exchange buys the $100 Home Depot gift card no. 12345 from the user for $85. If the user elects to receive their funds as a credit at Amazon.com, the gift card exchange server 100 can issue the user an e-certificate for $85 or send a message to Amazon.com indicating that the user should be given a temporary credit of $85 in their account that they can use to begin shopping. The gift card exchange server 100 then sends a message to Home Depot that the balance on card number 12345 is to be used to purchase a new gift card (e.g. card number 54321) so that card 12345 will no longer have any value. This information can be kept locally on a computer system of the merchant (e.g. Home Depot) as well as on the database 110. In addition or alternatively, a notification that the exchanged card 12345 no longer has value is sent to the gift card data aggregator 180 so that other merchants or services can determine that card number 12345 no longer has value. In one embodiment, the new gift card number from the issuer (e.g. a new Home Depot gift card number 54321) having a credit value of $100 can then be sold to a third party-typically for a discount (e.g. $95). Once sold, the gift card exchange then profits by the difference between the buy and sell price (e.g. $10).

In one embodiment, the gift card exchange server releases the hold on the credit once a new gift card has been issued or once it is confirmed that the redeemed card no longer has any value. In another embodiment, the release on the credit is issued once the newly issued gift card has been sold (e.g. a newly issued $100 Home Depot gift card sold to a third party of reseller for $95).

In another embodiment, depending on the business relationship between the gift card exchange and various merchants, the merchant may agree to refund all or a portion of the original gift card amount to the gift card exchange rather than merely provide a new card in exchange for the old gift card. For example, upon presentation of the gift card number by the gift card exchange server along with an indication that the card has been sold by its owner, Home Depot may return, for example, $95 of the original $100 it was paid for the card to the gift card exchange. Home Depot keeps $5 of the transaction. The gift card exchange can then pay the holder of the credit (e.g. the retail merchant) the amount of the gift card purchase price (e.g. the $85) and keep the difference (e.g. $95-85=$10). As soon as the gift card exchange server receives the funds back from the original issuer of the gift card, it may release the hold put on the credit at the retailer.

As will be appreciated, there are numerous other ways of preventing the user from attempting to re-use the card number that they have sold to the gift card exchange service.

If the user does not want the proceeds from a gift card sale to be transferred electronically, then the gift card exchange server 100 transmits a voucher, e-certificate, a code (e.g. numeric, alpha-numeric, bar code, QR code) photographic or graphic image, or other such code to the user's computer or mobile device. The received code can be printed, entered, displayed or otherwise presented by the user to one of the kiosks 140 (via e.g., a kiosk touch screen or other interface, optical sensors or scanners, near field communications with a mobile computing device, etc.) or other related machines (e.g., a Coinstar® coin counting machine) or a point of sale (POS) device at a participating merchant for the user to receive the cash proceeds and complete the transaction.

In one embodiment, the user presents the voucher to the kiosk or a human operator along with some personal identification. In another embodiment of the technology, the application software on the smart phone is programmed to send the device specific identifying information about the smart phone or other mobile computing device along with the personal ID information to further identify the user along with the acceptance of the offer. For example, the application software may send the international mobile equipment identifier (IMEI) number of the phone, its serial number or other identifier along with the personal ID information. In addition, the particular device specific identifying information selected may vary from transaction to transaction and may not be known to the user when the information is sent. In one embodiment, the gift exchange server computer asks the mobile device for the particular device specific identifying information. For one offer, the gift exchange server may ask for the device's IMEI number and for another offer, the gift exchange server may ask for the device's serial number. In another embodiment, the application software on the mobile computing device may randomly select a particular device specific identifier to associate with the transaction.

In yet another embodiment, the application software may prompt the user to enter a code, such as the last four digits of their social security number or driver's license number, and this code is combined with a randomly selected device specific identifier that is read from the mobile computing device to form a new code that is sent to the gift card exchange. In this way, the user is required to 1) present the voucher sent from the gift card exchange server and 2) be in possession of the phone with the matching device identifying information associated with the transaction, in order to be properly authenticated and complete the transaction at the kiosk or other location.

If the voucher code that was sent to the user were to be intercepted by someone other than the owner of the gift card, it is unlikely that the voucher would be presented for payment along with the smart phone having the matching device specific information. Because the system can randomly select different codes for different transactions or offers, the chances that a hacker could supply the gift card exchange server with fabricated data for gift card exchange transactions is lessened.

In one embodiment, the kiosks or merchant's POS devices are equipped with near field communications (NFC) or other wireless circuitry that allows the smart phone and kiosks/POS devices to communicate. Therefore, when the user offers a voucher code to the kiosks to complete a transaction for a sold gift card, the kiosk/POS can wirelessly query the smart phone for its IMEI number, serial number or other device specific identifier to see if it matches the information that was submitted when the card was sold. The kiosk or POS device may also interact with the mobile computing device to get the user to re-enter the code (e.g., the last four digits of their social security number). This code is then combined with the device specific information that is read from the mobile computing device selected for the transaction to see if the codes match. If all the information matches, then the funds (or other items of value) can be disbursed to the user to complete the card exchange transaction.

Once the hold on the credit is released, the transaction is complete. As will be appreciated, the technology disclosed allows a user to sell their gift cards from any location and to immediately begin to use the proceeds with other merchants. In addition, the gift card exchange is protected against loss because a hold is placed on any issued credit until the gift card is physically redeemed or otherwise drained of value.

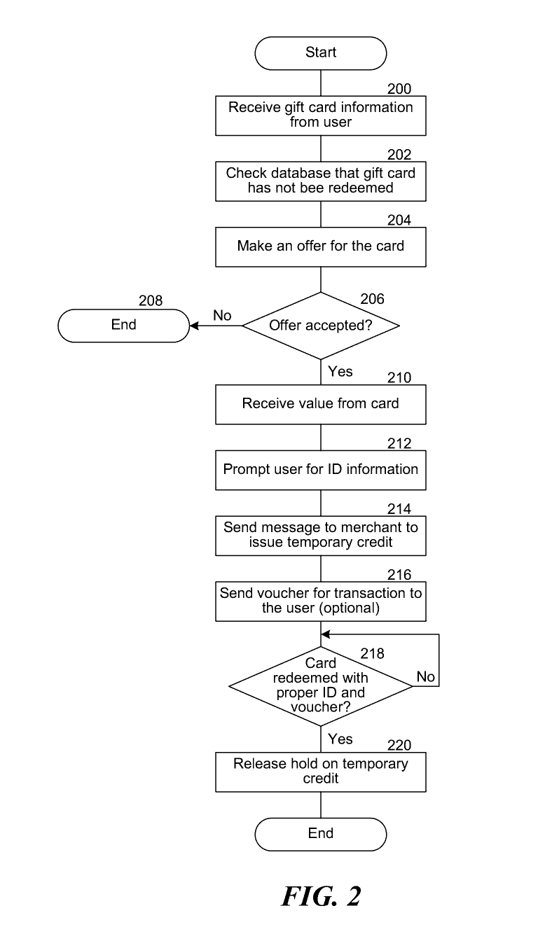

FIG. 2 is a flow chart of steps performed by a gift card exchange server computer in accordance with one embodiment of the disclosure. Although the steps shown are described in a particular order for ease of explanation, it will be appreciated that the steps could be performed in a different order or that different steps could be performed in order to achieve the functionality described.

Beginning at 200, the server computer receives gift card information from a remotely located computing device indicating that the user would like to exchange a gift card. At 202, the server computer checks a database or other memory or computer system to determine if the gift card still has value or if the gift card has been previously redeemed or drained of value. If the card still has value, the server computer presents an offer based on the gift card value to the user at 204. For example, if the card has $100 face value, the server computer 100 may present an offer of $85 for the card. At 206, the server computer determines if the offer is accepted. If the offer is not accepted, the process ends at 208. If the offer is accepted and the user has indicated that they would like a credit to use at another merchant's store, on an e-wallet balance or other account, the server computer takes steps at 210 to confirm that value is being received for the card (e.g., that the card has not been drained or otherwise has no value).

At 212, the server computer prompts the user to enter their ID information. If the user has elected to receive a credit in an account (such as an on-line retailer account), then the server computer sends a message at 214 to the computer system (or account keeper) that keeps track of the balance on such an account indicating the user's identity (e.g. name, customer number or other identifier) and the amount of the credit to be applied. The message also indicates that a temporary hold should be placed on the credit. The merchant or account manager therefore knows that the user can shop with the credit amount but should not be allowed to pay for items purchased with the credit until the hold is removed.

At 216, the server computer sends the user a voucher or other code representing the transaction. In some embodiments, the user is required to present the code along with the card to a kiosk or to a gift card exchange operator to release the hold on the credit. In other embodiments, the voucher is not sent and the user is just required to present the gift card to the kiosk to release the hold.

At 218, the server computer holds the transaction in abeyance until the server receives a message that the gift card has been received by a kiosk. In the embodiment shown, the server receives a message that the user has presented the gift card along with the appropriate ID and voucher (if used) to a remotely located kiosk.

At 220, the server computer transfers the proceeds from the transaction or sends a corresponding indication to the merchant or other account manager along with a message indicating that the hold on the credit can been released. The user is then free to consummate a prior purchase that was held in escrow or otherwise use the issued credit to pay for selected goods and services or to have them shipped/performed. In another embodiment, the server may transfer the funds to the merchant or other account manager when the offer is accepted along with an indication that a hold should be placed on the funds. However, if the transaction is not completed and the card value not received by the server within a certain time period, the funds should be returned. In yet another embodiment, the funds can be transferred to the retailer account once a replacement card has been purchased with the user's card and the replacement gift card has been sold.

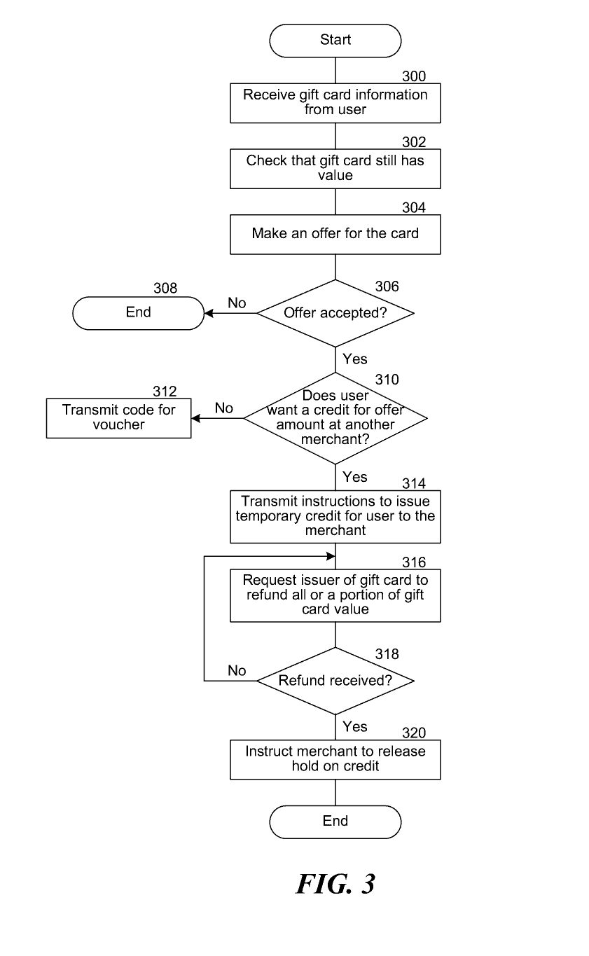

FIG. 3 shows a number of steps performed by the server computer system 100 to exchange a gift card in accordance with another embodiment of the disclosure. Beginning at 300, the server computer receives gift card information from a user via the user's computing device. At 302, the server computer checks to see if the gift card still has value. This can be done by querying the database 110, sending a message to the merchant that issued the gift card or by querying the gift card data aggregator 180 or by some combination of these steps. Assuming that the gift card still retains some or all of its value, the gift card exchange server presents an offer for the card at 304.

At 306, the gift card exchange server determines if the user has accepted the offer. It not, the process ends at 308. If the offer is accepted, then the gift card exchange server 310 determines if the user has elected to receive the proceeds of the offer as a credit at a third party merchant. If not, the server computer sends a voucher for the amount of the offer to the user at 312. If the user has elected to receive a credit, then the server computer 100 sends a message to the third party merchant that the user should be given a temporary credit for the amount of the offer at 314.

At 316, the gift card exchange server sends a request to the original issuer of the gift card asking that all or a portion of the value of the gift card be refunded to the gift card exchange. For example, Home Depot may refund $95 of the $100 gift card to the gift card exchange and keep the remaining $5. At 318, the gift card exchange server determines if the refund amount has been received. If not, the process returns to 316.

Once the refund amount has been received, the gift card exchange server instructs the third party merchant to release the hold on the credit that was given to the user. Such an instruction can be explicit or implicit by for example, sending the merchant the credit amount once it is received from the original issuer of the gift card.

As will be appreciated from the above, the gift card exchange system described allows a user to initiate and perform all or at least a portion of a transaction to exchange a gift card without having to be physically present at a kiosk or other location. In addition, the user is given the satisfaction of being able to immediately shop and/or order goods and services with the proceeds of the sale before physically redeeming the card.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include any number of clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

In general, the detailed description of embodiments of the described technology is not intended to be exhaustive or to limit the technology to the precise form disclosed above. While specific embodiments of, and examples for, the technology are described above for illustrative purposes, various equivalent modifications are possible within the scope of the described technology, as those skilled in the relevant art will recognize. For example, while processes, blocks, and/or components are presented in a given order, alternative embodiments may perform routines having steps, or employ systems having blocks, in a different order, and some processes or blocks may be deleted, moved, added, subdivided, combined, and/or modified. Each of these processes, blocks, and or components may be implemented in a variety of different ways. Also, while processes, blocks, and or components are at times shown as being performed in series, these processes, blocks, and/or components may instead be performed in parallel, or may be performed at different times.

The teachings of the described technology provided herein can be applied to other systems, not necessarily the system described herein. The elements and acts of the various embodiments described herein can be combined to provide further embodiments.

These and other changes can be made to the described technology in light of the above Detailed Description. While the above description details certain embodiments of the technology and describes the best mode contemplated, no matter how detailed the above appears in text, the described technology can be practiced in many ways. Details of the described technology may vary considerably in its implementation details, while still being encompassed by the technology disclosed herein. As noted above, particular terminology used when describing certain features or aspects of the described technology should not be taken to imply that the terminology is being redefined herein to be restricted to any specific characteristics, features, or aspects of the technology with which that terminology is associated. In general, the terms used in the following claims should not be construed to limit the described technology to the specific embodiments disclosed in the specification, unless the above Detailed Description section explicitly defines such terms. Accordingly, the actual scope of the described technology encompasses not only the disclosed embodiments, but also all equivalent ways of practicing or implementing the described technology.

I/We claim:

1. A method implemented by a gift card exchange server computer, the method comprising:
receiving information from a user about a gift card to be exchanged for value from a computing device;
determining a value of the gift card;
presenting an offer value to the user for the gift card that is based on the value of the gift card;
determining if the user accepts the offer value;
if the user accepts the offer value:
querying the user if they would like to receive the offer value as a merchant credit, and if so
sending a message to the merchant to issue a temporary credit that the user can use to purchase goods or services from the merchant, wherein the temporary credit is on hold;
receiving an indication that the value of the gift card has been received; and
in response to receiving the indication, removing the hold on the credit.

2. The method of claim 1, wherein the server computer transmits a message to an electronic database of card values that the gift card no longer has value once the indication has been received.

3. The method of claim 1, wherein receiving the indication includes receiving a message that the gift card has been received from the user at a remotely located kiosk.

4. A method implemented by a gift card exchange server computer, the method comprising:
receiving information from a user about a gift card to be exchanged for value from a computing device;
confirming that the gift card retains some value;
presenting an offer value to the user for the gift card that is based on the gift card's value;
determining if the user accepts the offer value;
if the user accepts the offer value:
querying the user if they would like to receive the offer value as a merchant credit, and if so
sending a message to the merchant to issue a temporary credit that the user can use to purchase goods or services from the merchant, wherein the temporary credit is on hold;
requesting that at least a portion of the value of the gift card be refunded from an issuer of the gift card, wherein the portion returned is greater than the offer value that was accepted for the gift card; and
instructing the merchant to release the hold on the credit upon receiving the refund from the issuer of the gift card.

5. The method of claim 4, wherein the server computer transmits a message to an electronic database of card values that the gift card no longer has value once the refund has been received.

6. At least one tangible, computer-readable medium storing instructions that are executable by a processor to:
receive information from a user's computing device about a gift card to be exchanged;
confirm that the gift card retains some value;
present an offer value to the user for the gift card that is based on the gift card's value;
determine if the user accepts the offer value;
if the user accepts the offer value:
query the user if they would like to receive the offer value as a merchant credit, and if so
send a message to the merchant to issue a temporary credit that the user can use to purchase goods or services from the merchant, wherein the temporary credit is on hold.

7. The computer readable medium of claim 6 further comprising instructions that are executable by the processor to:
receive an indication that the gift card value has been received; and
remove the hold on the credit.

8. The computer-readable medium of claim 6, further comprising instructions that are executable by the processor to transmit a message to an electronic database of card values that the gift card no longer has value.

9. The computer-readable medium of claim 6, further comprising instructions that are executable by the processor to:
receive an indication that the gift card has been received at a remotely located kiosk.

10. A computer readable medium with instructions thereon that are executable by a gift card exchange server computer to perform the steps of:
receiving information from a user's computing device about a gift card to be exchanged for value;
presenting an offer value to the user for the gift card that is based on the gift card's value;
determining if the user accepts the offer value;
if the user accepts the offer value:
querying the user if they would like to receive the offer value as a merchant credit, and if so
sending a message to the merchant to issue a temporary credit that the user can use to purchase goods or services from the merchant, wherein the temporary credit is on hold;
requesting that a portion of the value of the gift card be refunded by an issuer of the gift card, wherein the portion refunded is greater than the offer value that was accepted for the gift card; and
instructing the merchant to release the hold on the credit upon receiving the refund from the issuer of the gift card.

11. The computer-readable medium of claim 10, further comprising instructions that are executable by the processor to transmit a message to an electronic database of card values that the gift card no longer has value.

12. The computer-readable medium of claim 10, further comprising instructions that are executable by the processor to:
receive an indication that the gift card has been received at a remotely located kiosk.
